(19) United States
(12) Patent Application Publication
(10) Pub. No.: US 2011/0149567 A1
(43) Pub. Date: Jun. 23, 2011

(54) High Power LED Street Light Structure

(76) Inventor: Zhirong LEE, Wenzhou (CN)

(21) Appl. No.: 12/641,879

(22) Filed: Dec. 18, 2009

(51) Int. Cl. F21V 1/00

(52) U.S. Cl. 362/235

(57) ABSTRACT

Present application disclosed and claimed a type of street light, particularly a high power LED light, where a multi-sided body, ranging from 4 to 12 sides, is used to house LED lights and then connected to PCB inside a main chassis, connected by a heat ring. This type of high power LED street light provides a simple design for lost-cost production of street lighting that is long-lasting and results in low maintenance cost to the use and care of such street lighting.

### FIELD AND BACKGROUND OF THE INVENTION

The present invention relates generally to street light structure where LED lights are used to produce lighting, resulting in lesser consumption of electricity and lesser need for maintenance and thus substantial cost-saving.

Traditionally, street lighting is done by incandescent lighting, Halogen lighting, Sodium vapor lighting, or fluorescent lighting. Incandescent lighting consumes lots of power and generates substantial heat. Moreover, not enough lighting is produced by this traditional method.

Halogen lighting, though produces strong lighting effect, also consumes a lot of electricity.

Fluorescent lighting uses less electricity, but requires a lot more monitoring and maintenance to replace burnout lights.

Sodium vapor lighting, though consumes less electricity compared to incandescent light, contains mercury in some version and is a source of pollution concern to the environment.

### SUMMARY OF PRESENT INVENTION

Present invention provides a multi-sided structure, such as a hexagonal structure, that uses a number of low wattage LED light, each is around 0.5 W-3 W, so that they are arranged on the “fan” part of the multi-sided structure, which has an aluminum plate that houses the LED lights, where a layer of water-proofing washer is situated between the fan and the aluminum plate.

A lens is used on the outside surface of said LED lights, so that the lighting effect is focused and adjusted more effectively for lighting purpose.

LED light is the new trend for general lighting, since it uses roughly 20% of the electricity used to produce equivalent amount of lighting by a high-pressure Sodium light. Besides, LED light is more environmentally friendly because it contains no lead or mercury and thus does not create the pollution associated with the two types of metal that are known to be harmful to the environment and to human health.

The street lighting based upon the LED lights allows working temperature between −20° C. and +65° C. and has a wide range of applicability than other type of lighting, in addition to the save electricity cost.

Also, the use of aluminum plate provides a light-weight yet heavy-duty structure for long-term use, and thus is good for street lighting purpose.

### DESCRIPTION OF THE DRAWINGS

The accompanying drawings, which are incorporated in and constitute a part of this specification, illustrate the preferred embodiments of the invention and together with the description, serve to explain the principles of the invention, but are not intended to limit the scope of present invention to the extent present invention is applicable.

FIG. 1 shows the main side view of present LED street light structure.

FIG. 2 shows the structural cross-sectional view of present LED street light, along the A-A orientation in FIG. 1.

FIG. 3 shows the exploded view of present LED street light, with components drawn out for numbering identification.

### DETAILED DESCRIPTION OF PREFERRED EMBODIMENT

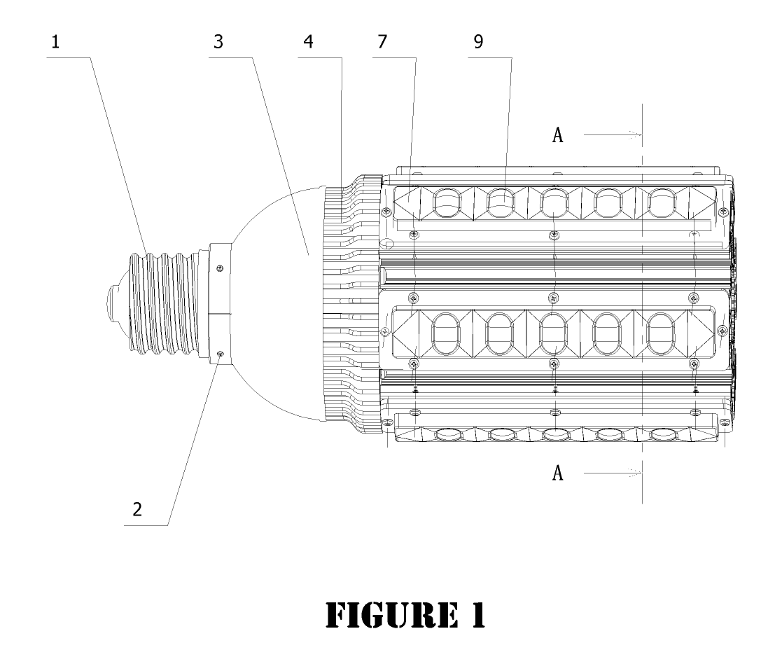

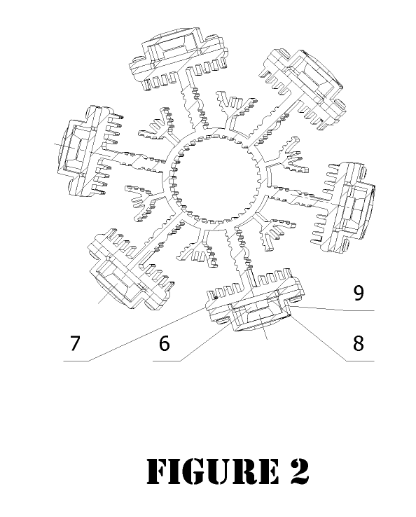

The high power LED street light of present invention primarily consists of a head portion 1, which connected to a head connector 2 to a main chassis 3, which is then attached to a multi-sided body 7 (here in this particular embodiment, it is a hexagonal body, having 6 fans), via heat ring 4, as shown in FIG. 1 and FIG. 2.

A printed circuit board (PCB) 5 is located inside said main chassis 3, to provide the electrical connection to a plurality of LED lights 6 placed on the outside surface of the “fan” on said hexagonal body 7.

The A-A line in FIG. 1 forms the reference plane for the profile image of the FIG. 2, showing the 6-sided structure of the hexagonal body 7.

As shown in FIG. 2, on each “fan” of said hexagonal body 7, a string of LED lights 6 is placed on an aluminum plate 8. An optical lens 9 is located on the outside surface of each of the LED light 6.

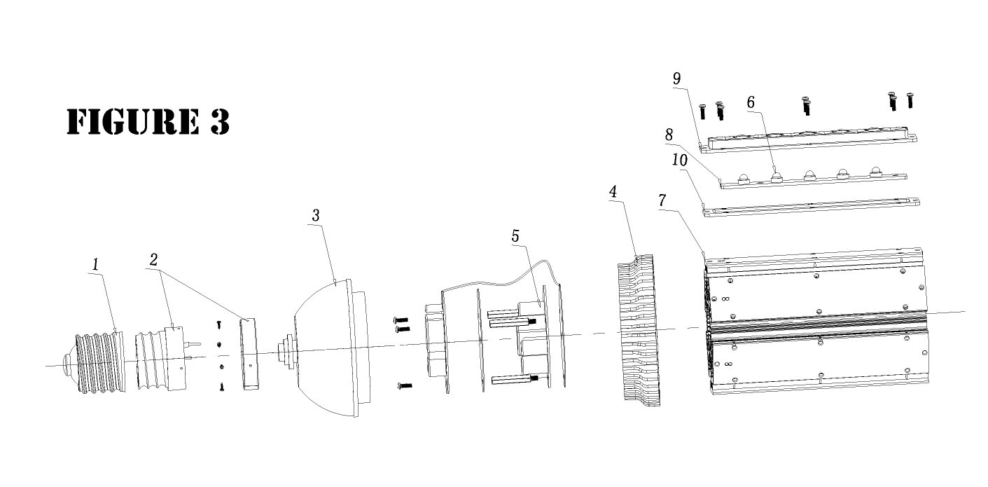

A layer of washer piece 10 is sandwiched between said aluminum plate 8 and each one of the six “fan” portion of said hexagonal body 7, to provide for a water-proof structure, as exemplified in FIG. 3, which is an exploded view of the components.

Although the present disclosure uses the example of a hexagonal body, the same principle can be applied to alternative embodiment of high power LED light wherein the string of LED lights can be placed on a four-sided, eight-side, ten-sided or twelve-sided structure, depending implementation.

What is claimed is:

1. A high power LED street light, comprising:
A head portion;
A head connecter;
A main chassis containing a printed circuit board inside;
A heat ring;
A plurality of LED lights;
A hexagonal body where each of its six fans has a washer piece sandwiched between said fan surface and an aluminum plate upon which said LED lights are located, so that said washer piece serves to provide water-proofing function; and,
A cover lens on the outside surface of each LED light.

2. The street light of claim 2, wherein the LED light has power rating between 0.5 W to 3 W.

3. A high power LED street light, comprising:
A head portion;
A head connecter;
A main chassis containing a printed circuit board inside;
A heat ring;
A plurality of LED lights;
A multi-sided body where the fan in each side has a washer piece sandwiched between said fan surface and an aluminum plate upon which said LED lights are located, so that said washer piece serves to provide water-proofing function; and,
A cover lens on the outside surface of each LED light.

4. The street light of claim 3 wherein the multi-sided body can be four-, six-, eight-, ten or twelve-sided, containing the amount of fans accordingly.
